(19) United States
(12) Patent Application Publication
(10) Pub. No.: US 2012/0181386 A1
(43) Pub. Date: Jul. 19, 2012

(54) Eccentricity vector control with continuous or quasi-continuous maneuvers

(76) Inventor: Vaclav Majer, Annapolis, MD (US)

(21) Appl. No.: 12/930,679

(22) Filed: Jan. 13, 2011

(51) Int. Cl. B64G 1/10

(52) U.S. Cl. 244/158.8

(57) ABSTRACT

A method of managing an eccentricity vector of a geosynchronous satellite orbit is provided. The method includes determining a desired target locus of an acquisition control of a satellite in a geosynchronous orbit, where the acquisition control ensures that an osculating trajectory of the satellite converges in mean to the target locus. Further, the method includes determining a solar pressure perturbation to the geosynchronous satellite orbit, honoring a hard eccentricity limit constraint of the satellite orbit using an ideal continuously controlled osculating trajectory, and controlling the eccentricity vector of the geosynchronous satellite orbit using a quasi-continuous control or a continuous control to mitigate or eliminate an annual solar pressure perturbation, where the quasi-continuous control or the continuous control maintains the satellite orbit within the hard limit osculating constraint and converges the eccentricity of the satellite orbit toward the ideal continuously controlled osculating trajectory of the geosynchronous satellite orbit.

### FIELD OF THE INVENTION

The current invention relates to satellite control. More particularly, the invention relates to controlling a mean eccentricity of a geosynchronous satellite orbit using continuous and quasi-continuous control.

### BACKGROUND OF THE INVENTION

Managing orbital degradation of geostationary satellites over time is an on-going problem. Because of various external forces, such as forces exerted by the sun and the moon, it is necessary correct this degradation, where it is a goal to extend the lifetime of satellites to a maximum span. Because the lifetime of a satellite depends upon how long its supply of fuel lasts, any saved fuel may be used to extend the life of the satellite. Alternatively, the saved fuel can be removed from the satellite, thereby reducing the overall launch mass of the satellite, allowing more payload to be added to the satellite.

What is needed is a way to provide design and implementation of eccentricity control strategies, which target optimal minimum fuel target cycles in satellites.

### SUMMARY OF THE INVENTION

To address the needs in the art, a method of managing an eccentricity vector of a geosynchronous satellite orbit is provided. The method includes determining a desired target locus of an acquisition control of a satellite in a geosynchronous orbit, where the acquisition control ensures that an osculating trajectory of the satellite converges in mean to the target locus. Further, the method includes determining a solar pressure perturbation to the geosynchronous satellite orbit, honoring a hard eccentricity limit constraint of the satellite orbit using an ideal continuously controlled osculating trajectory, and controlling the eccentricity vector of the geosynchronous satellite orbit using a quasi-continuous control or a continuous control to mitigate or eliminate an annual solar pressure perturbation, where the quasi-continuous control or the continuous control maintains the satellite orbit within the hard limit osculating constraint and converges the eccentricity of the satellite orbit toward the ideal continuously controlled osculating trajectory of the geosynchronous satellite orbit.

According to one aspect of the invention, the quasi-continuous control or the continuous control includes using an ion plasma thruster or a chemical thruster.

In another aspect of the invention, the quasi-continuous control includes using episodic eccentricity maneuver deltas.

In a further aspect of the invention, the continuous control includes a varied continuous control rate of a thruster output.

### BRIEF DESCRIPTION OF THE DRAWINGS

FIG. 1 shows a graph of daily high frequency oscillations modulated by a luni-solar envelope, and amplitude excursion by solar pressure drive.

FIG. 2 shows a graph of an optimal target mean eccentricity with different compensation values, according to one embodiment of the current invention.

FIG. 3 shows a graph of an example of 1 year of γ=0.5 sunsynch control after a 42 day acquisition phase from an initial osculating eccentricity of e=0, according to one embodiment of the current invention.

FIG. 4 shows a graph of how daily maneuvers track the continuous control locus as it acquires the 50% sun synch target and holds it in mean, according to one embodiment of the invention.

FIG. 5 shows a graph of how sun-synch deltas follow the sun for 1 year, according to one embodiment of the current invention.

FIG. 6 shows a graph of how discrete program includes daily deltas for 7 of every 8 days to track the 50% sun synch continuous program, according to one embodiment of the current invention.

FIG. 7 shows a graph of monthly maneuvers track the continuous control locus as it acquires the 50% sun synch target and holds it in mean, according to one embodiment of the current invention.

FIG. 8 shows a graph of monthly 50% sun-synch deltas follow the sun for 1 year, according to one embodiment of the invention.

FIG. 9 shows a graph of how daily maneuvers track the continuous control locus as it acquires the 100% sun synch target and holds it in mean, according to one embodiment of the current invention.

FIG. 10 shows a graph of how daily maneuvers track 100% sun-synch deltas follow the sun for 1 year, according to one embodiment of the current invention.

### DETAILED DESCRIPTION

The current invention provides a method of using geosynchronous station keeping eccentricity vector target cycles combined with continuous control and quasi-continuous control programs for tracking them either with low thrust, high specific impulse ion thrusters such as a stationary plasma thruster (SPT), xenon ion propulsion systems (XIP), or with high thrust, moderate specific impulse chemical thrusters.

For the same change in velocity (ΔV), ion thrusters must be fired for a much longer duration than chemical thrusters. That duration may include several shorter firings, however, due either to electric power limitations or the desire to limit long-arc ΔV losses, or both. Thus, there may be one or more small-ΔV ion thruster firings each day over several days in order to exert eccentricity vector station keeping control. The net effect of the quasi-continuous episodic eccentricity deltas from each firing may be modeled as a continuous eccentricity vector control rate. Conversely, an optimal continuous control rate program may be implemented by quasi-continuous impulsive eccentricity deltas, even for large impulsive deltas separated by many orbital revolutions.

The current invention provides the design and implementation of eccentricity control strategies, which target optimal minimum fuel target cycles using continuously or quasi-continuously firing thrusters. By ensuring that only control rates or deltas which counter the large amplitude effects of solar pressure on eccentricity are applied, the controls to achieve optimal ΔV performance in the presence of orbit determination, maneuver implementation, and orbit propagation modeling errors.

Eccentricity trajectories are denote by

$$t ↦ e = [ \begin{matrix}h \\ k\end{matrix} ] ≡ [ \begin{matrix}e cos ( ω + Ω ) \\ e sin ( ω + Ω )\end{matrix} ]$$

the true of date non-singular eccentricity vector elements of a geosynchronous vehicle at julian day, t, from julian epoch J2000. Here e is the orbit eccentricity, ω is the argument of perigee, and Ω is the right ascension of the orbit ascending node. Clearly, (r, θ)=(e, ω+Ω) are the polar coordinates of the cartesian point (h, k), and like all polar coordinates, are singular at the origin, (h, k)=(0, 0). The origin defines geostationary eccentricity and so plays a central role in geosynchronous operations. For this reason only non-singular eccentricity elements, [h k], are used in this discussion.

The time evolution of near-geosynchronous eccentricity is due to precession and nutation of the vector-to-perigee caused by earth gravity, luni-solar gravity, and solar pressure. There are three principal periodic signatures, representative values for the period and amplitude of which are listed in Table 1. On the scale of geosynchronous eccentricity station keeping tolerances, the amplitudes of all but the solar pressure perturbation are negligible and do not require control. On the scale of a single station-keeping planning and correction cycle (e.g., 14 days), the solar pressure perturbation presents as a secular drive; the maximum magnitude of eccentricity can be as high as twice the solar pressure amplitude, depending on the initial eccentricity vector.

TABLE 1
Large amplitude annual solar pressure induced perturbations require
control; biweekly luni-solar gravity and daily earth gravity perturbations
are typically ignored.
Perturbations of Eccentricity

| perturbation | period | | amplitude |
|---|---|---|---|
| earth gravity | 24 | hours | 30 micros |
| luni-solar gravity | 14 | days | 50 micros |
| solar pressure | 366 | days | 500 micros |

The e=[h k] vector dynamics in the neighborhood of the origin are given by

$$\frac{d e}{d t} = \frac{2 Tu - Rv}{V} ,$$

where
F=Ru+Tv, is the perturbation specific force,
u=[cos α sin α], is the radial unit vector,
v=[−sin α cos α], is the along-track unit vector,

V is synchronous velocity, and α is the right ascension of the spacecraft. The perturbation specific force, F,

F=L+S+P+δ,

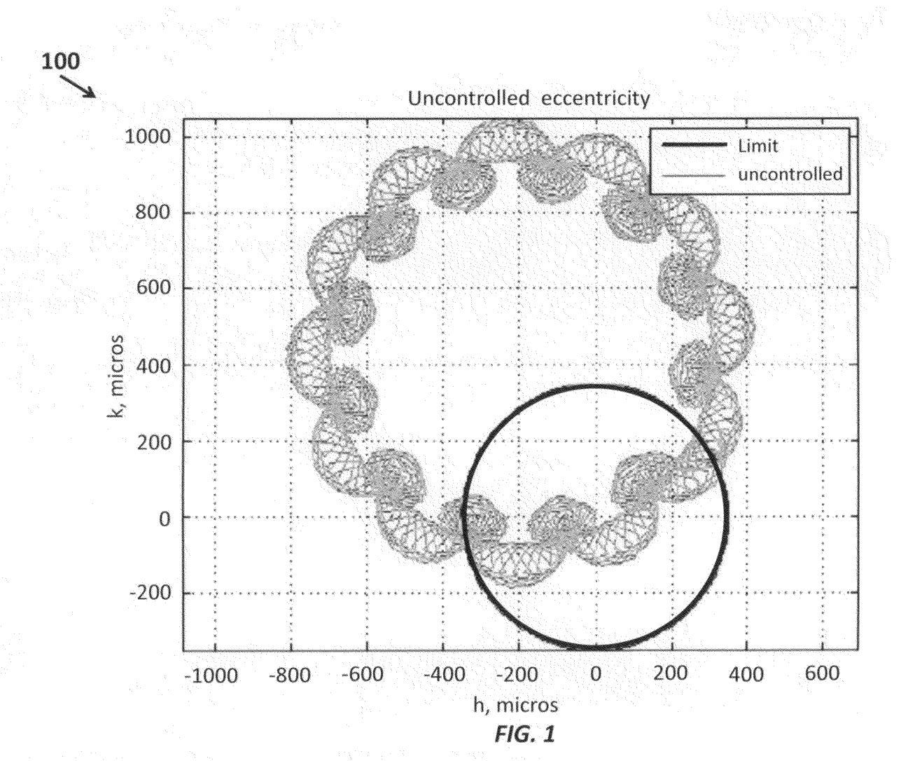

includes the projections into the orbit plane of third body lunar gravity, L, third body solar gravity, S, solar pressure, P, and the control program, δ, the design and implementation of which are the objects of this invention. The gravitational perturbations are included in the examples below but are not detailed here. The solar pressure perturbation is represented in this discussion as

$$P = - \frac{{C}_{p} Af}{m} {( \frac{r}{R} )}^{2} s = - {K}_{p} {f ( \frac{r}{R} )}^{2} s ,$$

where s is the projection into the orbit plane of the vehicle-to-sun unit vector, A is a representative vehicle area, m is the vehicle mass, Cₚ is a non-dimensional coefficient with nominal value Cₚ=1, f is the solar flux at 1 AU, r is the distance from the vehicle to the sun, and R=1 AU. The constant, Kₚ=CₚA/m, is the vehicle ballistic solar pressure coefficient. Typical values of Kₚ for geosynchronous communication spacecraft are in the range 0.0250≦Kₚ≦0.0500 m²/kg. In operational practice the quantity, mKₚ, is replaced by the projection into s of a finite element surface model. FIG. 1 shows the evolution of eccentricity over 1 year for Kₚ=0.0450 m²/kg and an initial eccentricity of e=[0 0] 100. The value Kₚ=0.0450 is used in all of the examples to follow. In FIG. 1, shown are daily high frequency oscillations that are modulated by a luni-solar envelope, causing the 14-day loops. Solar pressure drive is responsible for the large amplitude eccentricity excursion, from, zero initially to an eccentricity in excess of 1000×10⁻⁶ after 180 days.

As mentioned above, the eccentricity station keeping method of the current invention provides control of the large amplitude solar pressure perturbation. That is, control design focuses on management of the mean eccentricity, \hat{f}(t),

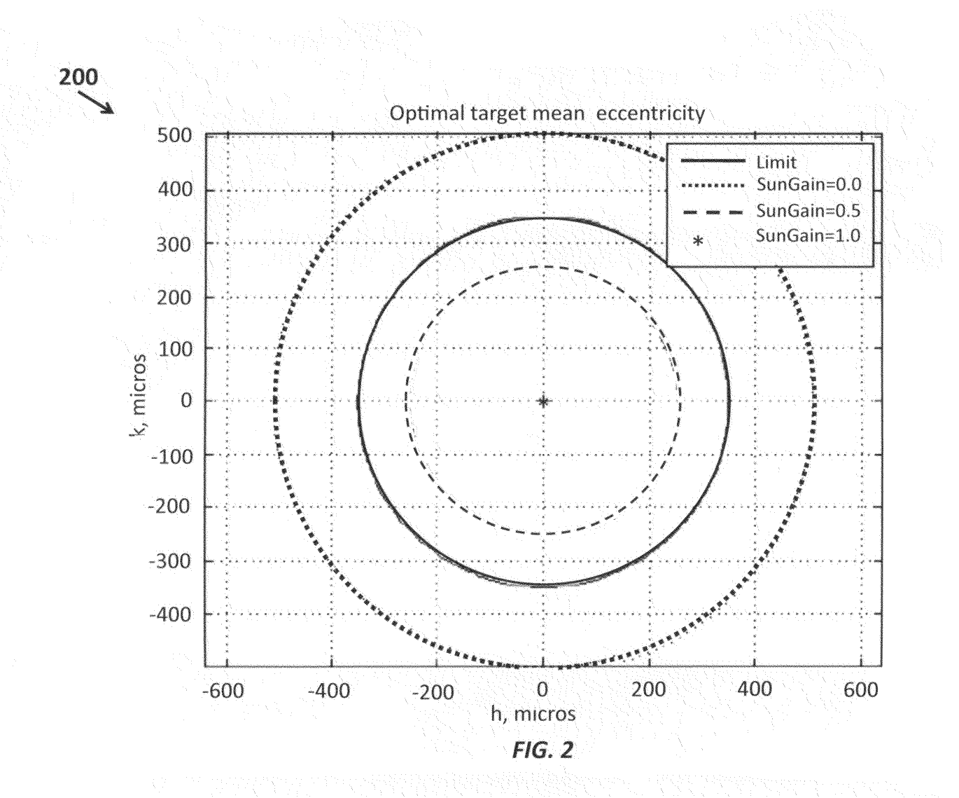

satisfying

$$\frac{d f}{d t} = ( 1 - γ ) \frac{2 {T}_{p} u - {R}_{p} v}{V} ,$$

where P=Rₚu+Tₚv is the solar perturbation specific force. Two exemplary control strategies provided here are:
Maximum Compensation: nulls the solar pressure perturbation completely, γ=1, so that dê/dt=0. The maximum compensation mean eccentricity target is a point (see FIG. 2).
Sun-Synchronous: nulls only some or none of the solar pressure perturbation, 0≦γ≦1, so that dê/dt=(1−γ)P. The sun-synch mean eccentricity target is a circle (see FIG. 2).

FIG. 2 shows a maximum compensation, γ=1, where the target locus is a point, having the result of nulling the solar pressure perturbation 200. Further shown is the sun-synch control gain, γ=0.5, which is sufficient to hold the mean eccentricity below the hard control limit of 350 micros. Also shown is a case where applying no sun-synch control, γ=0, it is insufficient to meet the hard limit.

Clearly, maximum compensation control is the special case, γ=1, of sun-synchronous control. The center of the sun-synch target circle coincides with the origin of the maximum (hard limit) eccentricity control locus. Some control authority must be expended (acquisition/initialization) to center the mean eccentricity on a particular hard limit center, [Hz Kz]. The hard limit center is typically at the eccentricity space origin, but may be offset for certain colocation strategies. The examples are without loss of generality centered at the origin; the hard limit radius is 350 micros.

Given the initial value problem,

$$\frac{d e}{d t} = \frac{2 Tu - Rv}{V} ,$$

F=Ru+Tv=L+S+P+δ,

e(t₀)=e₀,

the object of continuous station keeping eccentricity control is to design control function, t [symbol] (t), such that the osculating trajectory, t [symbol] e, acquires a desired mean eccentricity target locus t [symbol] f in the [h k] plane and then maintains that target locus. The current invention provides such control functions for the maximum compensation and sun-synchronous target loci, a point and a circle, respectively.

Since the e dynamics are independent of e, the difference f(t)−e(t)=f(t₀)−e(t₀), of two trajectories is constant; that is, trajectories starting from different initial vectors are congruent rigid body translations of one another. Therefore, given a desired target locus t [symbol] \hat{f}, the acquisition control

$${δ}_{a} ( t ; {t}_{0} , T ) = \frac{f ( {t}_{0} ) - \hat{e} ( {t}_{0} )}{T}$$

for t ∈ [t₀, t₀+T],

δₐ(t; t₀,T)=0 for t ∈ [t₀+T, ∞),

removes any mean initialization error, ê(t₀)−f(t₀), over a T day acquisition phase. Here ê is the mean eccentricity corresponding to osculating eccentricity e. The acquisition control ensures that the osculating trajectory, e, converges in mean to the target locus, f, over T days.

Underlying the initial acquisition phase is persistent maintenance in mean of the target locus. The maintenance control is given by

δₘ(t; γ)=−γP for t ∈ t₀, ∞],

where γ=1 for the maximum compensation strategy and γ<1 for the sun synchronous strategy. The complete acquisition plus maintenance control program is

δ(t;t₀,T,γ)=δₐ(t; t₀, T)+δₘ(t; γ).

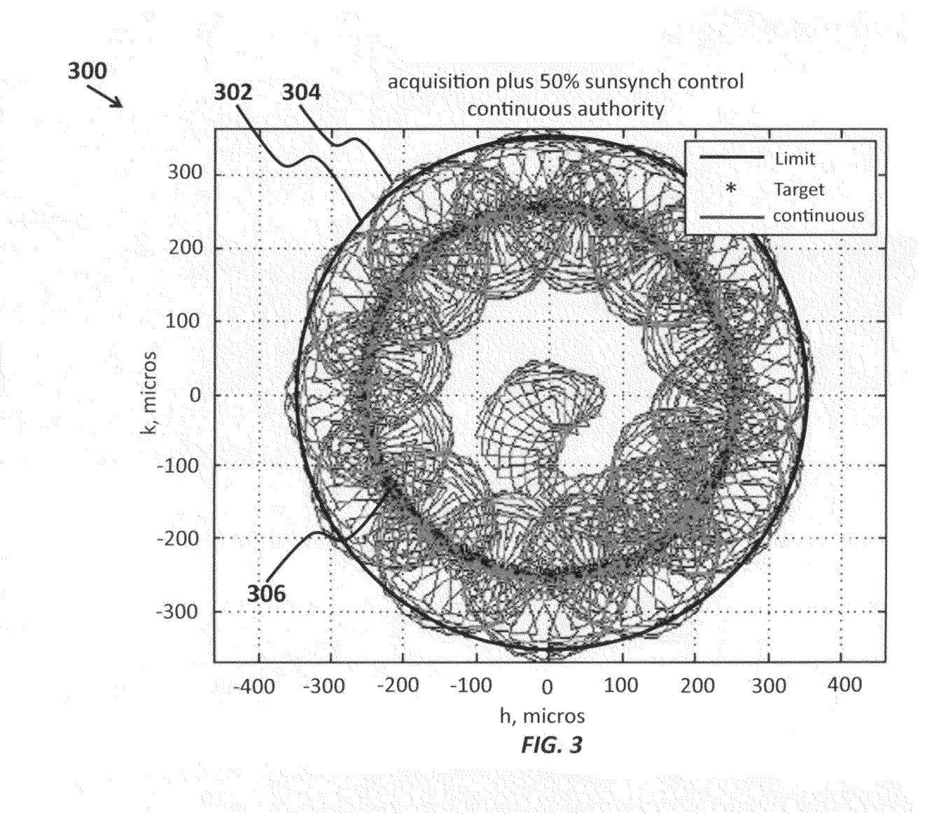

FIG. 3 is an example of 1 year of γ=0.5 sunsynch control after a 42 day acquisition phase from an initial osculating eccentricity of e=0 300. Shown is the initial eccentricity at [−50, −50] mdeg outside of the 50 mdeg hard limit 302 control locus, the acquisition control drives the osculating eccentricity 304 toward the fixed max comp mean eccentricity target 306 at the center of the control locus. The maintenance control holds the target in mean, leaving only the biweekly lunar cycle uncontrolled.

Sun-synch control gains, γ<1, save fuel over maximum compensation, γ=1, by managing the solar pressure perturbation only to the extent necessary to meet the hard limit osculating constraint. In the example, a mean eccentricity control radius of 250 micros is sufficiently small to ensure that osculating eccentricity remains below 350 micros. Unmanaged eccentricity can attain 1000 micros for the ballistic solar pressure, Kₚ=0.0450, used in the examples. Simply centering the mean eccentricity on the origin [initialization/acquisition] reduces the maximal excursion to 500 micros, and using sun-synch control gain, γ=0.5, reduces the maximal excursion to 250 micros. Depending on the station longitude, it is often possible to supply the control authority for γ≦0.5 with one part drift and eccentricity maneuvers; maximum compensation, γ=1, typically requires two part drift and eccentricity maneuvers in order to supply the required eccentricity authority.

An important attribute of this invention is a continuous control program applied to the osculating eccentricity trajectory to achieve convergence in mean to a mean eccentricity target locus. In practice, the maintenance phase does not run open loop in the open-ended interval [t₀, ∞). Instead, episodic orbit determination corrects the propagated e(tₖ) at OD epochs tₖ, k=0, 1, 2, . . . The initial value problem is then re-solved in interval [tₖ, ∞), and the re-acquisition control automatically removes any orbit propagation abutment error revealed by orbit determination over the previous station keeping control cycle [tₖ₋₁, tₖ]. The algorithm is thus self-correcting on the time scale of the station keeping control cycle.

And neither is the control program continuous in practice. The ideal continuous control program serves as the osculating target for the quasi-continuous discrete control program to be implemented by the vehicle.

Continuous eccentricity control is not practical in on-station operations for most spacecraft designs since it would preclude the usual 1 rev/day pitch rotation to maintain nadir-pointing payload, where the continuous control program is very nearly constant in magnitude and inertial direction over one orbital day.

Instead, the continuous control program is replaced by episodic eccentricity deltas. There may be one or more deltas per day (e.g., 4 maneuvers per 1 day with ion plasma thruster station keeping) or one or more days per delta (e.g., 1 maneuver every 28 days for traditional chemical thruster station keeping).

The quasi-continuous control program ensures that the vehicle's osculating eccentricity trajectory, t [symbol] g, is centered on the ideal continuously controlled osculating trajectory, t [symbol] e, between episodic eccentricity maneuver deltas, Δgⱼ at times tⱼ, j=1, . . . The deltas are given by

Δgⱼ=e(tⱼ₊₁)−g(tⱼ₊₁),

where t [symbol] g satisfies the series of uncontrolled initial value problems,

$$\frac{d g}{d t} = \frac{2 Tu - Rv}{V} ,$$

F=Ru+Tv=L+S+P+δ,

g(tⱼ₋₁)=gⱼ₋₁, with

g₀=eₒ.

Observe that this is a closed loop feedback control in that determining the discrete eccentricity delta at maneuver time, requires propagation of the uncontrolled trajectory over the interval, [tⱼ−1]. Only the solution over interval, [tⱼ−1 tⱼ], is retained for the quasi-continuous intramaneuver trajectory. The maneuver times, tⱼ, need not be equi-spaced, and neither need they be frequently spaced.

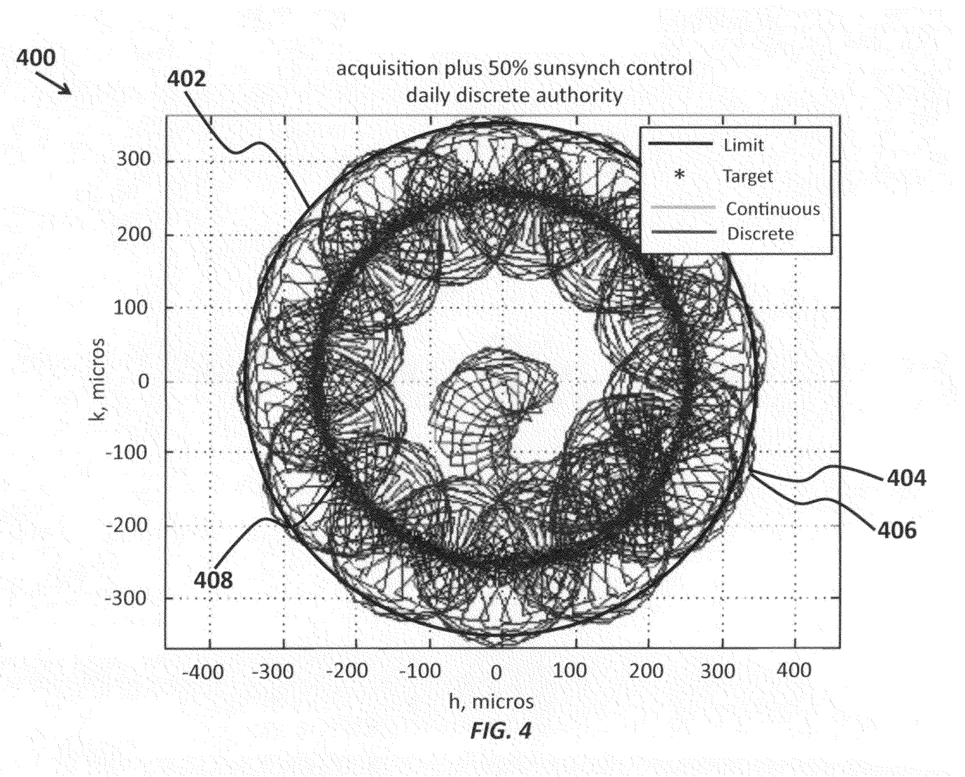

FIG. 4 shows how quasi-continuous discretely controlled trajectory tracks the underlying continuous trajectory with daily eccentricity vector deltas for gain, γ=0.5 400, where shown are the hard limit 402 control locus, a continuous 404 an discrete 406 osculating eccentricity and the eccentricity target 408, where the continuous 404 an discrete 406 eccentricity controls are shown in close agreement. Here daily maneuvers track the continuous control locus as it acquires the 50% sun synch target and holds it in mean, where only half of the long term solar pressure perturbation is controlled.

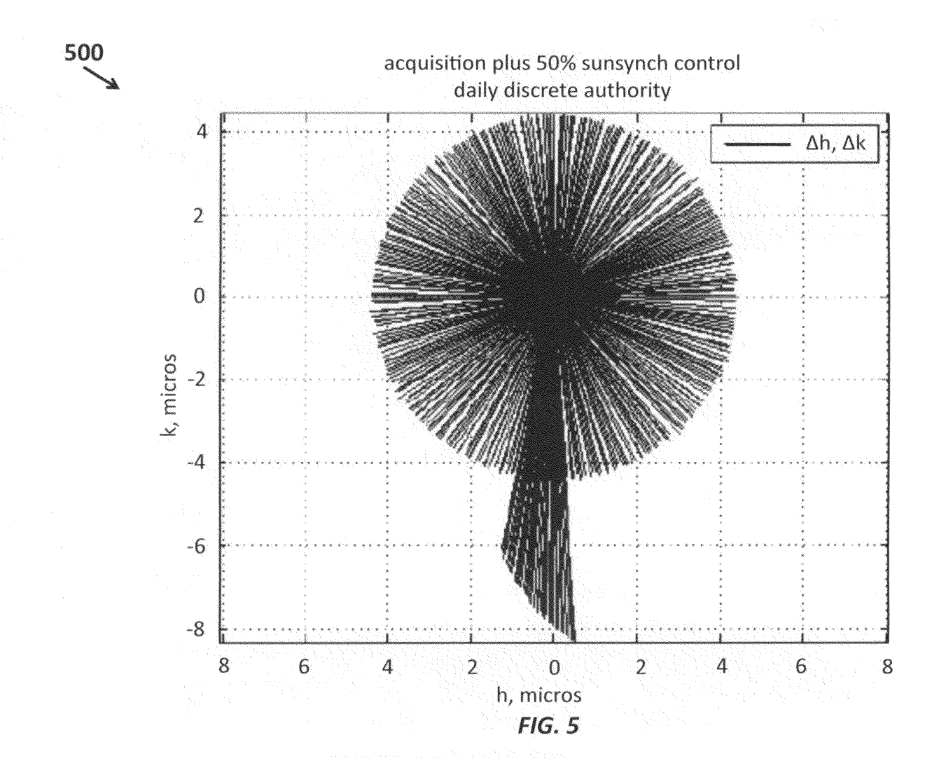

FIG. 5 shows a map of the corresponding daily quasi-continuous delta eccentricity 500, where the deltas for the 42 day acquisition phase are clearly visible near azimuth 270.

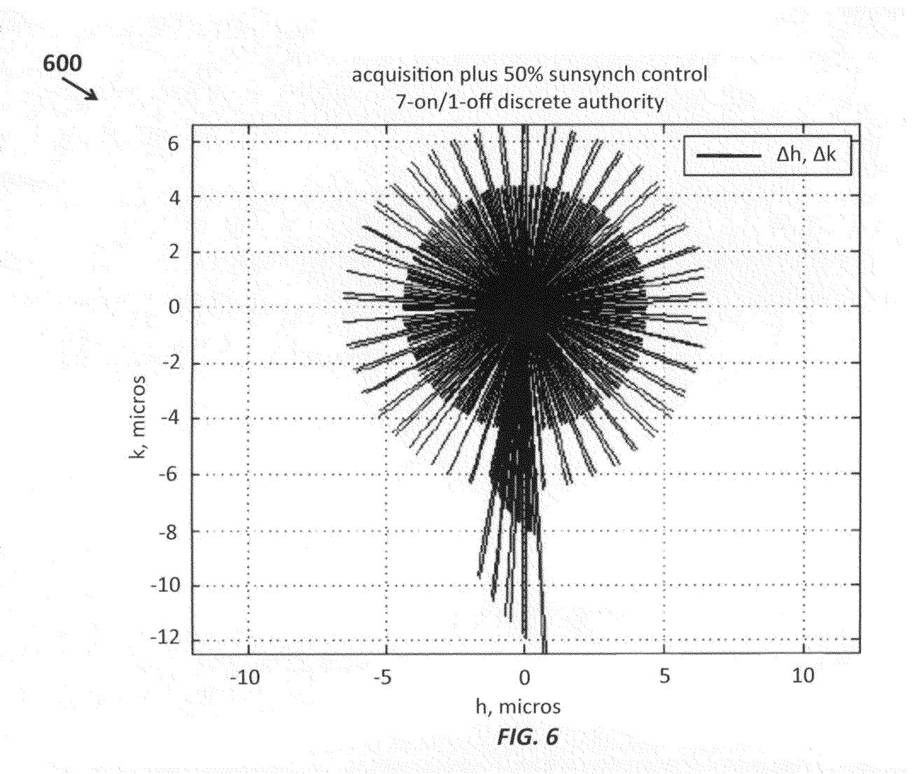

FIG. 6 shows a 7 day ON/1 day OFF maneuver program 600 for the same scenario in FIG. 5. Here, daily 50% sun-synch deltas are shown follow the sun for 1 year; the 42 day acquisition phase deltas are clearly visible near azimuth 270 deg. According to one embodiment, the discrete program includes daily deltas for 7 of every 8 days to track the 50% sun synch continuous program. Each pair of 150% sized deltas brackets the no-burn day, which can be used for orbit determination or spacecraft housekeeping. The eccentricity phase plane trajectory, not shown, is indistinguishable from daily control.

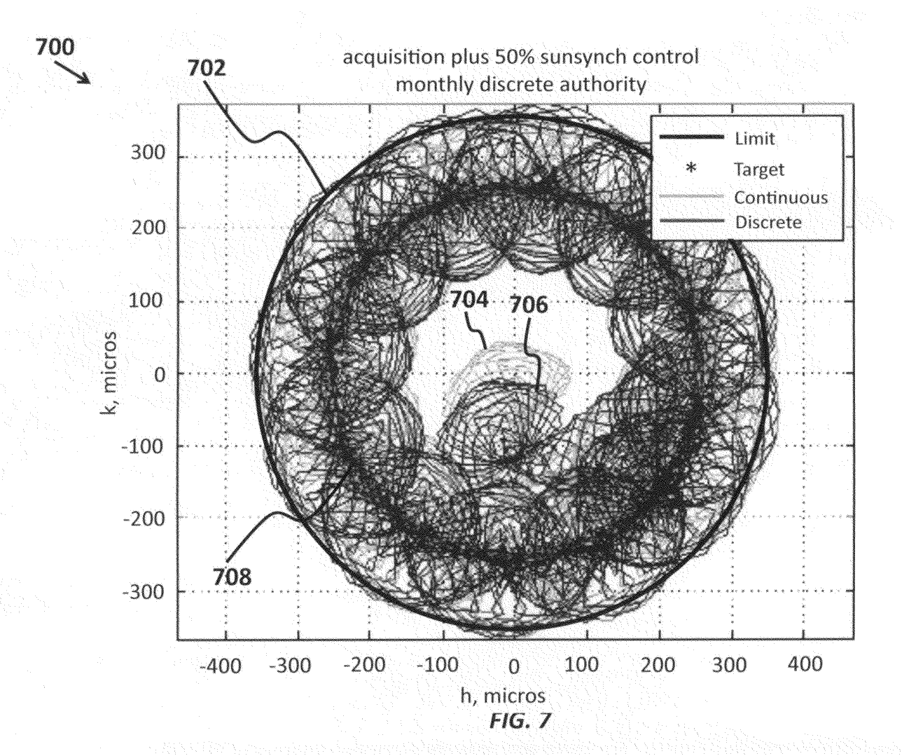

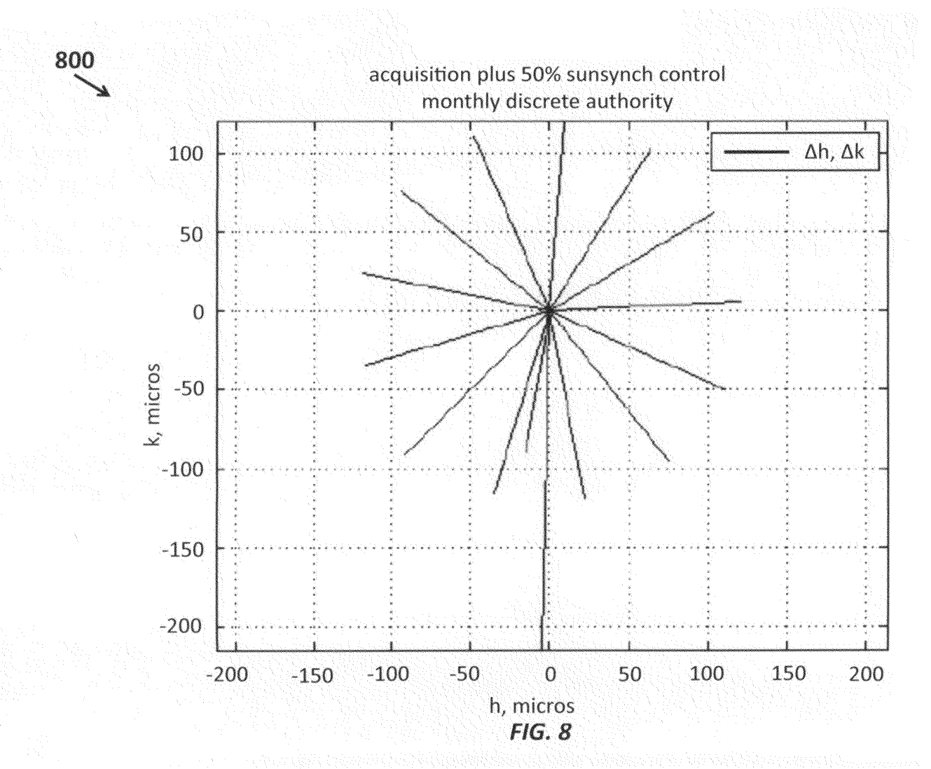

To illustrate that the discrete program need not be frequent, FIGS. 7 and 8 are the trajectory rose 700 and maneuver rose 800, respectively, for a 1 day ON/27 day OFF discrete control program such as might be used with chemical thrusters, where FIG. 7 shows the hard limit 702, continuous eccentricity control 704, discrete eccentricity control 706, and the target eccentricity 708. Shown are monthly maneuvers, such as in traditional chemical station keeping, track the continuous control locus as it acquires the 50% sun synch target and holds it in mean. Only the half of the long term solar pressure perturbation is controlled. Further FIG. 8 shows Monthly 50% sun-synch deltas follow the sun for 1 year; the 42 day acquisition phase deltas are clearly visible near azimuth 270 deg.

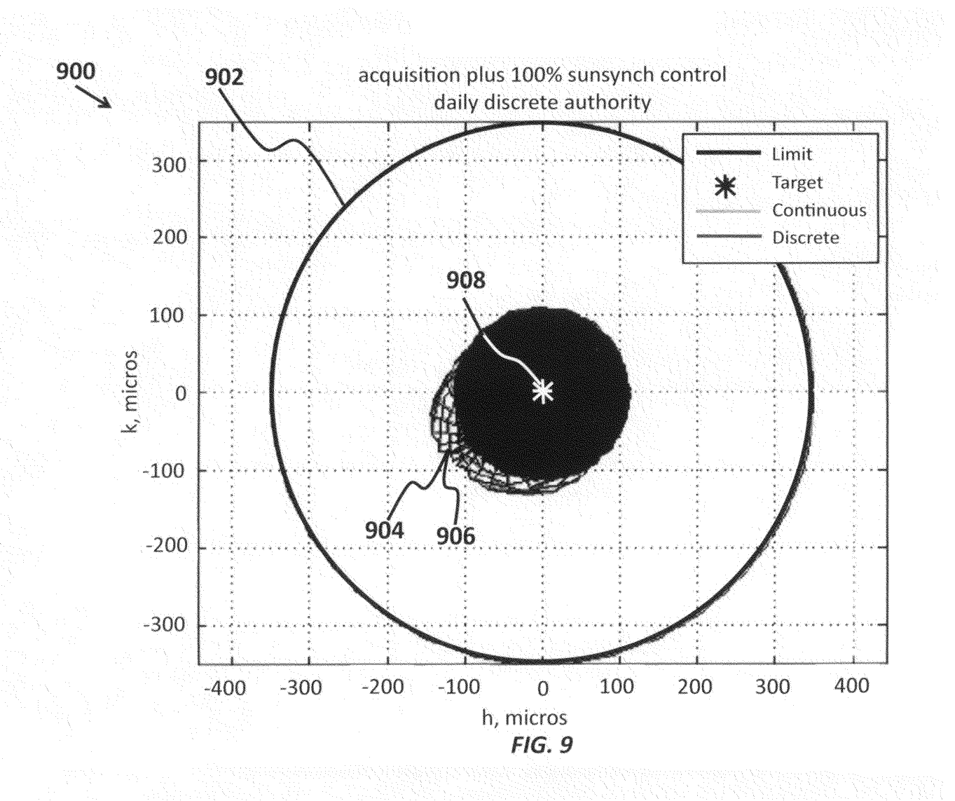

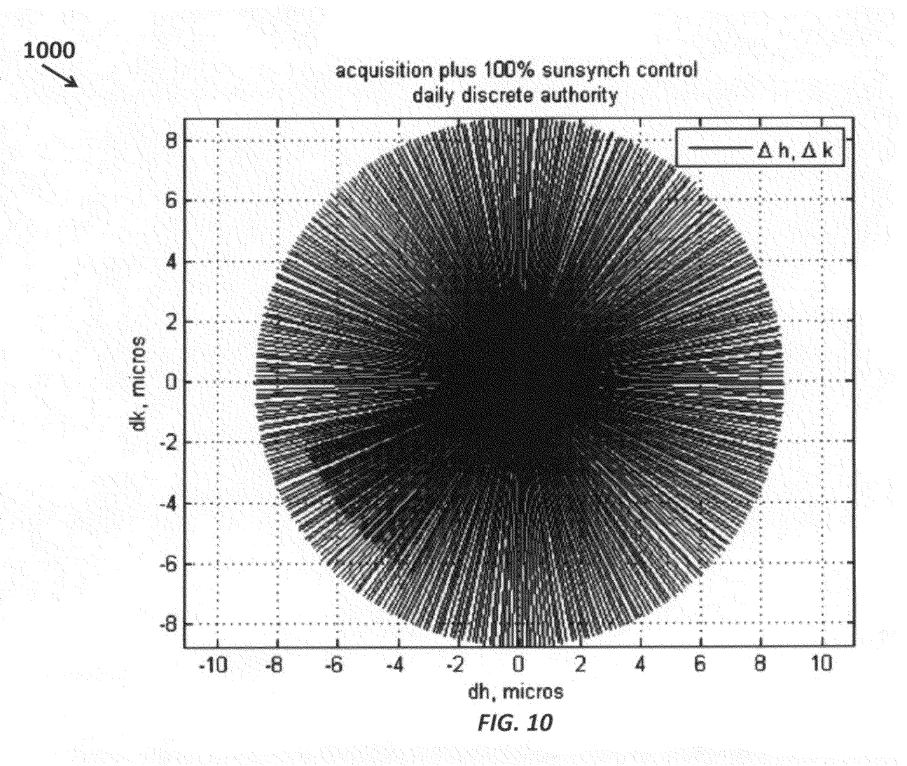

Finally, FIGS. 9 and 10 show γ=1 maximum compensation control for the same acquisition and maintenance scenario of the trajectory rose 900 and maneuver rose 1000. FIG. 9 a graph of how daily maneuvers track the continuous control locus as it acquires the 100% sun synch target and holds it in mean, where shown are the hard limit 902, continuous eccentricity control 904, discrete eccentricity control 906, and the target eccentricity 908, where the continuous 904 and discrete 906 eccentricity controls are shown in close agreement. The entire long-term solar pressure perturbation is controlled. Further, FIG. 10 shows how daily 100% sun-synch deltas follow the sun for 1 year; the 42 day acquisition phase deltas are concentrated in the third quadrant.

The fuel use for continuous eccentricity control is proportional to the net continuous eccentricity authority, E,

E(t₀,T,γ)=∫ₜδ(s;t₀,T,γ)ds

The quasi-continuous control authority, F, is the sum of the eccentricity deltas,

$$F ( {t}_{0} , T , d T , γ ) = {\sum }_{j} \vert Δ {f}_{j} \vert ,$$

supplied by the quasi-continuous controls, Δfⱼ with maneuver period, dT. The more frequent are the maneuvers, the smaller is each maneuver. The net eccentricity authority, however, remains virtually constant for each strategy, independent of maneuver frequency. That is,

$${lim}_{dT -> 0} F ( {t}_{0} , T , d T , γ ) = E ( {t}_{0} , T , γ ) ,$$

for fixed strategy, γ. The quasi-continuous control authority ratio for maneuver period, dT, using control gain, γ, is

$$f ( d T , γ ) = \frac{F ( {t}_{0} , T , d T , γ )}{E ( {t}_{0} , T , γ )} = \frac{F ( {t}_{0} , T , d T , γ )}{F ( {t}_{0} , T , d T = 0 , γ )} .$$

The implementation defined in this note has the property that f(dT, γ)<1 for 0<dT, post-acquisition; the savings are essentially the discretization error of the quasi-continuous approximation to the continuous control: the discrete control “cuts corners” relative to the continuous control. The fuel savings of sun-synch relative to maximum compensation are characterized by

$$g ( d T ) = \frac{E ( {t}_{0} , T , d T , γ = 0 )}{E ( {t}_{0} , T , d T , γ = 1 )} .$$

Table 2 summarizes the performance of the continuous and quasi-continuous controls for a range of sun-synchronous control gains.

TABLE 2
The non-zero entries for E and F at γ = 0 reflect the control overhead of
acquisition, 13.2%, in these examples. With the exception of acquisition,
the quasi-continuous discrete control is 2% to 3% less expensive the
continuous control program it tracks.
Eccentricity Control Authority and Efficiency

| | |
|---|---|
| Continuous | Discrete |

| | E | | F | |
|---|---|---|---|---|
| Sun Gain γ % | micros | 1 − g % | micros | 1 − f % |
| 0 | 476 | 86.8 | 502 | −5.5 |
| 25 | 1201 | 66.6 | 1178 | 1.9 |
| 50 | 1950 | 45.7 | 1903 | 2.4 |
| 75 | 2747 | 23.6 | 2673 | 2.7 |
| 100 | 3594 | 0.0 | 3500 | 2.6 |

The current invention provides the design and implementation of eccentricity control strategies, which target optimal sun-synchronous and maximum compensation target cycles using continuously or quasi-continuously firing thrusters. By ensuring that only control rates or deltas which counter long-period, large amplitude eccentricity perturbations are applied, the controls achieve optimal ΔV performance in the presence of orbit determination, maneuver implementation, and orbit propagation modeling errors.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example, the control applications may be episodic with arbitrary or irregular period. The reference trajectory may be corrected or re-defined during any cycle based on the results of routine orbit determination or following orbit adjustments for purposes other than stationkeeping.

All such variations are considered to be within the scope and spirit of the present invention as defined by the following claims and their legal equivalents.

What is claimed:

1. A method of managing an eccentricity vector of a geosynchronous satellite orbit comprising:
a. determining a desired target locus of an acquisition control of a satellite in a geosynchronous orbit, wherein said acquisition control ensures that an osculating trajectory of said satellite converges in mean to said target locus;
b. determining a solar pressure perturbation to said geosynchronous satellite orbit;
c. honoring a hard eccentricity limit constraint of said satellite orbit using an ideal continuously controlled osculating trajectory; and
d. controlling said eccentricity vector of said geosynchronous satellite orbit using a quasi-continuous control or a continuous control to mitigate or eliminate an annual solar pressure perturbation, wherein said quasi-continuous control or said continuous control maintains said satellite orbit within said hard limit osculating constraint and converges said eccentricity of said satellite orbit toward said ideal continuously controlled osculating trajectory of said geosynchronous satellite orbit.

2. The method of claim 1, wherein said quasi-continuous control or said continuous control comprises using an ion plasma thruster or a chemical thruster.

3. The method of claim 1, wherein said quasi-continuous control comprises using episodic delta-eccentricity maneuvers.

4. The method of claim 1, wherein said continuous control comprises a varied continuous control rate of a thruster output.
